(19) United States
(12) Patent Application Publication
(10) Pub. No.: US 2022/0253022 A1
(43) Pub. Date: Aug. 11, 2022

(54) ARTIFICIAL INTELLIGENCE REMOTE CONTROL DISTRIBUTED SYSTEM

(71) Applicant: Dongxu Zhang, Guangzhou (CN)

(72) Inventor: Dongxu Zhang, Guangzhou (CN)

(21) Appl. No.: 17/333,038

(22) Filed: May 28, 2021

(30) Foreign Application Priority Data
Feb. 8, 2021 (CN) 202110182990.5

(51) Int. Cl. G05B 13/02

(52) U.S. Cl. CPC G05B 13/0265

(57) ABSTRACT

The invention discloses an artificial intelligence remote control distributed system, comprising a main APP module, a first split module, a second split module, and a distributed module, wherein the main APP module performs data monitoring on the first split module and the second split module; the first split module and the second split module feed back data to the main APP module; the first split module and the second split module monitor the distributed module; data exchange between the first split module and the second split module. The invention has the following advantages: it can realize unmanned monitoring and management, improve labor efficiency, can cooperate with the ground and the air, has no dead angles in the monitoring angle in all directions, and has great advantages in improving labor efficiency and diversifying service scope.

### BACKGROUND OF THE INVENTION

### 1. Field of the Invention

The invention relates to the technical field of artificial intelligence, in particular to an artificial intelligence remote control distributed system.

### 2. Description of the Related Art

Artificial Intelligence, abbreviated as AI, is a new technological science that studies and develops theories, methods, technologies and application systems for simulating, extending and expanding human intelligence. AI is a branch of computer science. It attempts to understand the essence of intelligence and produce a new kind of intelligent machine that can react in a similar way to human intelligence. Research in this field includes robotics, language recognition, image recognition, natural language processing, and expert systems. Since the birth of AI, the theory and technology have become increasingly mature, and the field of application has continued to expand. It is conceivable that the technological products brought by AI in the future will be the “containers” of human wisdom. AI can simulate the information process of human consciousness and thinking. AI is not human intelligence, but it can think like humans and may exceed human intelligence.

With the continuous development of AI, it is no longer limited to the control of specific objects. The Internet is becoming more and more popular. An artificial intelligence remote control distributed system urgently needs to be studied.

### SUMMARY OF THE INVENTION

The objective of the invention is to solve the problems in the prior art, and provide an artificial intelligence remote control distributed system.

In order to solve the above technical problems, the invention provides the technical solutions as follows: an artificial intelligence remote control distributed system, comprising a main APP module, a first split module, a second split module, and a distributed module, wherein the main APP module performs data monitoring on the first split module and the second split module; the first split module and the second split module feed back data to the main APP module; the first split module and the second split module monitor the distributed module; data exchange between the first split module and the second split module.

Preferably, the first split module controls the second split module to run to the abnormal area of the distributed module.

Preferably, the second split module controls and corrects the abnormal area of the distributed module.

The invention has the following advantages: it can realize unmanned monitoring and management, improve labor efficiency, can cooperate with the ground and the air, has no dead angles in the monitoring angle in all directions, and has great advantages in improving labor efficiency and diversifying service scope.

### BRIEF DESCRIPTION OF THE DRAWINGS

FIG. 1 is a block diagram of an artificial intelligence remote control distributed system of the invention.

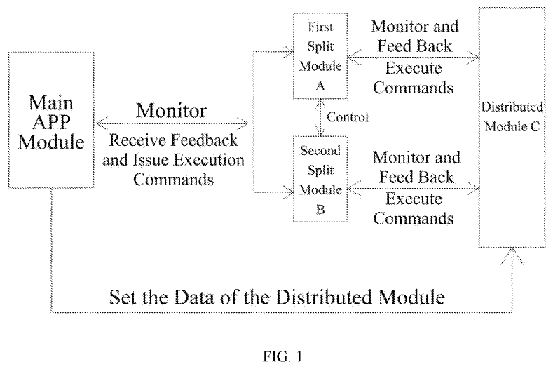

FIG. 2 is a flow chart of the application of the invention in production.

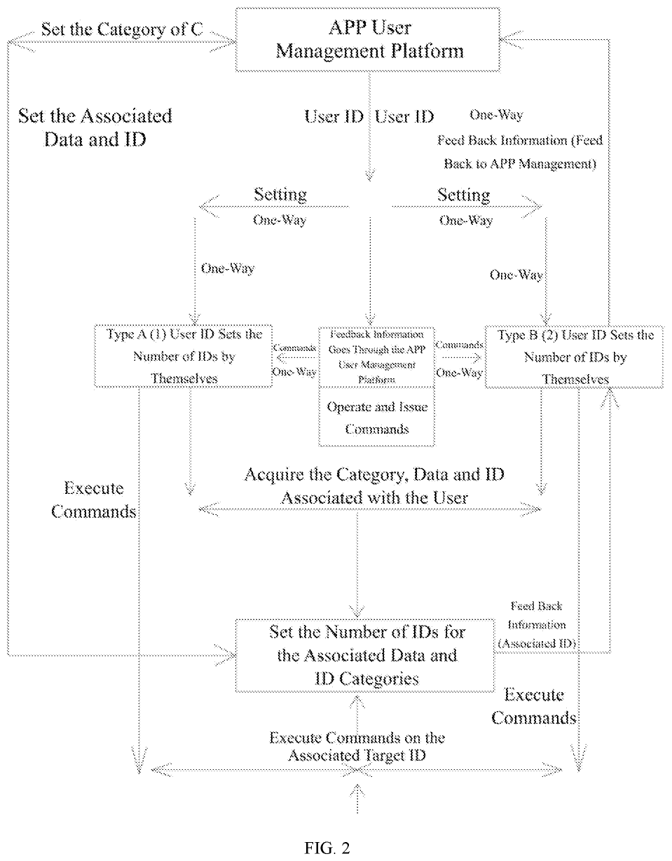

### DETAILED DESCRIPTION OF THE PREFERRED EMBODIMENTS

In the description of the invention, it should be understood that the orientation or positional relationship indicated by the terms “center”, “longitudinal”, “transverse”, “length”, “width”, “thickness”, “upper”, “lower”, “front”, “back”, “left”, “right”, “vertical”, “horizontal”, “top”, “bottom”, “inner”, “outer”, “clockwise”, “counterclockwise” etc. are based on the orientation or positional relationship shown in the drawings, and is only for the convenience of describing the invention and simplifying the description, but not indicate or imply that the pointed device or element must have a specific orientation, be constructed and operated in a specific orientation, and therefore cannot be understood as a limitation of the invention.

In addition, the terms “first” and “second” are only used for descriptive purposes, and cannot be understood as indicating or implying relative importance or implicitly indicating the number of indicated technical features. Thus, the features defined with “first” and “second” may explicitly or implicitly include one or more of these features. In the description of the invention, unless otherwise clearly defined, “plurality” means two or more.

In order to facilitate the understanding of the invention, the invention will be described in detail hereinafter with reference to the drawings.

In order to facilitate the understanding of the invention, the invention will be described in detail hereinafter with reference to the drawings.

The preferred embodiments of the invention are shown in the drawings. However, the invention can be implemented in many different forms and is not limited to the embodiments described herein. On the contrary, the purpose of providing these embodiments is to make the understanding of the disclosure of the invention more thorough and comprehensive.

With reference to the drawings, an artificial intelligence remote control distributed system, comprising a main APP module, a first split module, a second split module, and a distributed module, wherein the main APP module performs data monitoring on the first split module and the second split module; the first split module and the second split module feed back data to the main APP module; the first split module and the second split module monitor the distributed module; data exchange between the first split module and the second split module. The first split module controls the second split module to run to the abnormal area of the distributed module. The second split module controls and corrects the abnormal area of the distributed module.

The working principle of the invention: the main APP module monitors the first split module and the second split module, and the first split module and the second split module simultaneously monitor the distributed module; when the first split module monitors the abnormal area of the distributed module, the first split module controls the second split module to go to the abnormal area of the distributed module, and to control and correct the abnormal area of the distributed module.

The technical features of the above embodiments can be combined arbitrarily. To make the description concise, all possible combinations of the technical features in the above embodiments are not described. However, as long as there is no contradiction in the combination of these technical features, it should be regarded as the scope described in the specification. The above embodiments only express several implementation modes of the invention, and their description is relatively specific and detailed, but they should not be understood as a limitation on the scope of the invention. It should be understood that several modifications and improvements may be made by those of ordinary skill in the art without departing from the concept of the invention, which shall all fall within the protection scope of the invention. Therefore, the protection scope of the invention shall be subject to the appended claims.

1. An artificial intelligence remote control distributed system, comprising a main APP module, a first split module, a second split module, and a distributed module, wherein the main APP module performs data monitoring on the first split module and the second split module; the first split module and the second split module feed back data to the main APP module; the first split module and the second split module monitor the distributed module; data exchange between the first split module and the second split module.

2. The artificial intelligence remote control distributed system according to claim 1, wherein the first split module controls the second split module to run to the abnormal area of the distributed module.

3. The artificial intelligence remote control distributed system according to claim 2, wherein the second split module controls and corrects the abnormal area of the distributed module.
